(19) United States
(12) Patent Application Publication
(10) Pub. No.: US 2008/0312106 A1
(43) Pub. Date: Dec. 18, 2008

(54) Substrate Material for Analyzing Fluids

(75) Inventors: Ralph Kurt, Eindhoven (NL); Dirk Jan Broer, Geldrop (NL); Roel Penterman, Eindhoven (NL); Emiel Peeters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/096,920

(22) PCT Filed: Nov. 28, 2006
(86) PCT No.: PCT/IB2006/054486

§ 371 Date: Jun. 11, 2008

(30) Foreign Application Priority Data
Dec. 12, 2005 (EP) 05111941.0

(51) Int. Cl. C40B 60/04; B01J 19/00; B05D 3/06

(52) U.S. Cl. 506/35; 422/68.1; 427/510

(57) ABSTRACT

The invention relates to a substrate material for analyzing fluids which has first areas with a high porosity and second areas with a lower porosity.

### FIELD OF THE INVENTION

The present invention is directed to the field of devices for the detection of one or more analytes in a fluid sample, especially to the field of devices for the optical detection of biomolecules in aqueous solution.

### BACKGROUND OF THE INVENTION

The present invention is directed to the detection of analytes in fluids, especially to the detection of biomolecules in aqueous solution. The detection usually occurs in that way, that the fluid to be analyzed is provided on a substrate material, which contains binding substances for the analytes which are subject of the detection. Such a capture probe may be a corresponding DNA-strand in case the analyte is also a DNA-strand. The analytes in the fluid, which are usually equipped with a label, preferably an optical fluorescence label, will then be captured by the binding substance (in case of two complementary DNA strands this process is called hybridization or specific binding) and remain there even after the fluid is removed. The analyte may then be detected by optical means.

However, in prior art solutions, the substrate material was (more or less) uniform, thus quite an amount of analyte that was applied to the substrate material was not used for capture and detection.

### SUMMARY OF THE INVENTION

It is therefore an object of the present invention to provide a substrate material, which allows a quicker detection with a minute amount of analyte that needs to be present in the fluid.

This object is solved by a substrate material according to claim 1 of the present invention. Accordingly, a substrate material for analyzing one or more fluid samples for the presence, amount or identity of one or more analytes in the samples is provided, whereby

defined first areas on or with the substrate material are provided with at least one binding substance specific for at least one of said analytes, such first area(s) having an open porosity of ≧50% and ≦99% and

at least one defined second area on or with the substrate material is provided with an open porosity of ≧0% and ≦50%.

A substrate material according to the present invention has the following advantages over the prior art:

Since (at least) two different defined areas are present in the sample, the amount of analyte that is needed for detection can for most applications be reduced and so the efficiency of detection be increased.

As a consequence either the analysis time could be reduced or the detection sensitivity could be increased (or both).

Two different areas will also increase the mechanical stability (solid support) of the substrate material, which is advantageous if a pressure is applied e.g. to pump the analyte through the substrate material.

As the two regions also have different optical properties the signal (from first area) to background (nonspecific binding in second area) ratio improves.

Different regions can also (in a preferred embodiment) improve the thermal conductivity, allowing a better temperature control (faster and lateral homogeneous) e.g. during hybridization.

When these substrate materials are used for arrays, the spots of the array may according to an embodiment of the present invention be confined to the porous regions. Therefore the spots can be smaller and can be placed closer together.

It should be noted that in the sense of the present invention, the first areas may not necessarily be provided with the at least one binding substance over their total area and/or volume. According to an embodiment of the present invention, the first areas include regions, where no binding substance is present.

In the sense of the present invention, the term “porosity” especially means or includes the ratio of the volume of all the pores or voids in a material to the volume of the whole. In other words, porosity is the proportion of the non-solid volume to the total volume of material. In the sense of the present invention the term porosity is especially a fraction between 0% and 100%, e.g. typically ranging from less than 1% for solid granite to more than 90% for some materials like cotton.

In the sense of the present invention, the term “open porosity” (also called effective porosity) especially means or includes the fraction of the total volume in which fluid flow is effectively taking place.

According to an embodiment of the present invention, the at least one first and/or the at least one second area comprises at least 100 pores, according to an embodiment of the present invention more than 1000 pores, according to an embodiment of the present invention more than 10000 pores and according to an embodiment of the present invention more than 100000 pores.

According to an embodiment of the present invention, the at least one first and/or the at least one second area have an average pore size ranging from ≧10 nm to ≦10 μm, according to an embodiment of the present invention from ≧50 nm to ≦5 μm, according to an embodiment of the present invention from ≧100 nm to ≦2 μm and according to an embodiment of the present invention from ≧200 nm to ≦1 μm.

The pores can according to an embodiment of the present invention be arranged in a periodic pattern or according to an embodiment of the present invention just randomly distributed.

According to an embodiment of the present invention, the first areas comprise an open porous material with a preferred directionality of the pores perpendicular to the surface of the substrate material (i.e. in flow direction).

According to an embodiment of the present invention, the first areas comprise an open porous material, which has a substantial fraction of its inner surface that has an angle (10-90 degree) with respect to the normal of the substrate material, i.e. these surfaces have a component perpendicular to the average fluid flow through the substrate material.

According to an embodiment of the present invention, the first areas have an open porosity of ≧60% and ≦97%, according to an embodiment of the present invention, the first areas have an open porosity of ≧70% and ≦95%, according to an embodiment of the present invention, the first areas have an open porosity of ≧80% and ≦93%, according to an embodiment of the present invention, the first areas have an open porosity of ≧85% and ≦90%.

According to an embodiment of the present invention, the second areas have an open porosity of ≦40%, according to an embodiment of the present invention, the second areas have an open porosity of ≦30%, according to an embodiment of the present invention, the second areas have an open porosity of ≦20%, according to an embodiment of the present invention, the second areas have a porosity of ≦10%.

According to an embodiment of the present invention, the difference in porosity between said first areas and second areas is ≧20%, according to an embodiment of the present invention, the difference in porosity between said first areas and second areas is ≧40%, according to an embodiment of the present invention, the difference in porosity between said first areas and second areas is ≧60%, according to an embodiment of the present invention, the difference in porosity between said first areas and second areas is ≧80%.

According to an embodiment of the present invention, the first areas form discrete regions. According to an embodiment of the present invention, the second area is continuously formed around the first areas; however according to an embodiment of the present inventions, at least some of the second areas are discrete regions as well.

According to an embodiment of the present invention, the mean diameter of the first areas is ≧10 μm and ≦1 mm. According to an embodiment of the present invention, the mean diameter of the first areas is ≧20 μm and ≦800 μm, according to an embodiment of the present invention, the mean diameter of the first areas is ≧25 μm and ≦700 μm, according to an embodiment of the present invention, the mean diameter of the first areas is ≧50 μm and ≦600 μm. according to an embodiment of the present invention, the mean diameter of the first areas is ≧50 μm and ≦500 μm. according to an embodiment of the present invention, the mean diameter of the first areas is ≧100 μm and ≦250 μm.

According to an embodiment of the present invention, the substrate material comprises at least one transient region which is provided between and/or in connecting fashion between a first and a second area where the open porosity changes gradually (from the open porosity in first area to the open porosity in the second area).

This transient region is, according to an embodiment of the invention, limited to a typical size of ≦50 μm, according to an embodiment ≦20 μm, according to an embodiment ≦10 μm, according to an embodiment ≦5 μm in lateral direction. This lateral direction is defined as one would measure the distance between a region of said first areas and a region of said second areas, e.g. the distance in a plane parallel to the surface of the substrate material.

According to an embodiment of the present invention, the ratio of the total volume of the first areas (in mm³) to the total volume of the at least one second area (in mm³) is ≧0.05:1 and ≦50:1. According to an embodiment of the present invention, the ratio of the total area of the first areas (in mm³) to the total area of the at least one second area (in mm³) is ≧0.1:1 and ≦10:1. According to an embodiment of the present invention, the ratio of the total area of the first areas (in mm³) to the total area of the at least one second area (in mm³) is ≧0.5:1 and ≦6:1.

According to an embodiment of the present invention, the inner surface area of any of the first area(s) is by a factor X larger than the size of this area, whereby the factor X is ≧100, according to an embodiment ≧1000, according to an embodiment ≧10000 and according to an embodiment ≧1100000.

It should be noted, that the inner surface area can be measured e.g. by gas absorption experiments.

According to an embodiment of the present invention, the first areas are arranged in a regular and/or periodic array pattern.

According to an embodiment of the present invention, the material of the first areas and/or the second areas and/or the substrate as a whole is chosen from the group comprising

amorphous polymers, preferably from the group comprising PC (polycarbonate), PS (polystyrene), PMMA (polymethylmethacrylate), polyacrylates, polyethers, cellulose ester, cellulose nitrate, cellulose acetate, cellulose or mixtures thereof,

semicrystalline polymers, preferably from the group comprising PA (polyamide=nylon materials), PTFE (polytetrafluoroethylene), polytrifluoroethylene, PE (polyethylene), PP (polypropylene), or mixtures thereof,

rubbers, preferably from the group comprising PU (polyurethane), polyacrylates, silane based polymers such as PDMS (polydimethylsiloxane) or mixtures thereof,

gels (=polymer networks with fluid solvent matrix), preferably from the group comprising agarose gel, polyacrylamide gel or mixtures thereof

metals (such as aluminum, tantalum, titanium), alloys of two or more metals, doped metals or alloys, metal oxides, metal alloy oxides or mixtures thereof

or mixtures thereof. These materials have shown to be suitable materials within the present invention.

It should be noted that according to an embodiment, the first and second areas are made of somewhat the same material but differ e.g. by the degree of polymerization. According to another embodiment of the present invention, the first and second areas are made out of different materials.

According to an embodiment of the present invention, the thickness of the substrate material is ≧1 μm and ≦500 μm, according to an embodiment ≧5 μm and ≦200 μm, according to an embodiment ≧10 μm and ≦100 μm, and according to an embodiment ≧20 μm and ≦50 μm.

According to an embodiment of the present invention, the thickness of the first areas of the substrate material is ≧1 μm and ≦500 μm, according to an embodiment ≧5 μm and ≦200 μm, according to an embodiment ≧10 μm and ≦100 μm, and according to an embodiment ≧20 μm and ≦50 μm.

According to an embodiment of the current invention the thickness of the substrate material in at least a part of said second areas is larger than in said first areas. According to an embodiment of the current invention the thickness of the substrate material in at least a part of said second areas is ≧2 times larger, according to an embodiment ≧5 times, according to an embodiment ≧10 times, according to an embodiment ≧20 times larger than in said first areas.

According to an embodiment of the present invention, the average pore size in the first and second areas is the same in that way that the average pore size in the first areas is ≧0.5 times to ≦2 times the average pore size in the second areas. However, the open porosity is set as described above.

According to an embodiment of the current invention the thermal conductivity (in W/m K) in at least a part of said second areas is larger than in said first areas. According to an embodiment of the current invention the thermal conductivity (in W/m K) in at least a part of said second areas is ≧2 times larger, according to an embodiment ≧5 times, according to an embodiment ≧10 times, according to an embodiment ≧20 times larger than in said first areas.

According to an embodiment of the current invention the first and second areas differ in mechanical properties in that way that second areas are less elastic (lower elasticity) and less brittle compared to first areas, making the entire substrate material mechanically more stable and more robust against pressure applied.

According to an embodiment of the present invention, the first areas include regions, where no binding substance or non-specific binding is present. Such regions can for some applications within the present invention be used as reference for optical detection, as the analyte is flowing through it in the same way as through regions where binding substance(s) are present, but no specific binding can occur. Therefore these regions indicate if and how many non-specific binding occurs, resulting in an optical background signal, which is also present in the signal(s) from said regions of the first areas, which are provided with binding substance(s), and can thus be subtracted.

According to an embodiment of the present invention, the first area(s) show at least a first optical signal being substantially different from a second signal from said second area(s). The difference in optical signal might comprise the detected signal intensity, signal amplitude, signal length (e.g. a typical decay time), wavelength, or spectrum including fluorescence, emission, absorption, reflection, transmission or other optical signals or a combination thereof.

According to an embodiment of the present invention, the difference of the index of refraction of the substrate material in the first areas under wet conditions with the index of refraction of the fluid and/or the sample(s) is smaller than ≦0.2, according to an embodiment ≦0.1, according to an embodiment ≦0.05, according to an embodiment ≦0.02.

According to an embodiment of the present invention, the difference in the index of refraction of the substrate material in the first area(s) under dry conditions with the index of refraction of the second area(s) is larger than ≧0.1, according to an embodiment ≧0.2, according to an embodiment ≧0.3, according to an embodiment ≧0.5.

According to an embodiment of the present invention, the light scattering of the substrate material in the first area(s) compared with the light scattering of the second area(s) at least ≧2 times larger, according to an embodiment at least ≧5 times larger, according to an embodiment at least ≧10 times larger.

According to an embodiment of the present invention, the second areas are either optically transparent, absorbing, or reflecting (all of them at a predefined wavelength or a part of the optical spectrum used in the device for optical detection such as the corresponding excitation, fluorescence, absorption or emission wavelength.

According to an embodiment of the present invention, the second areas furthermore are adapted to amplify optical signals in a way that they become detectable by the detector system, e.g. by waveguiding, or a second fluorescent process. Assuming the substrate material is excited by blue light, the optical markers in the first areas might emit green light, which can be detected. The light scattered into second areas, could be directly reflected or wave guided towards the detector or it could itself excite fluorescent particles present in second areas, which than would emit red light, which could also detected by a sensor. Looking from top, one would observe a green spot surrounded by a red rim. At low concentrations i.e. a low optical signal one could improve detectability in this way.

The present invention furthermore relates to a method of making a substrate material according to the present invention, comprising a polymerization step.

The present invention furthermore relates to a method of making a substrate material according to the present invention, comprising a photo-polymerization step.

The present invention furthermore relates to a method of making a substrate material according to the present invention, comprising polymerization induced phase separation.

According to an embodiment of the present invention, the method of making a substrate material according to the present invention comprises photo-polymerization induced phase separation (PIPS).

According to an embodiment of the present invention, the method of making a substrate material according to the present invention comprises photo-polymerization induced diffusion (PID).

According to an embodiment of the present invention, the method of making a substrate material according to the present invention comprises the following steps:

a) Filling, preferably completely filling a preferably commercially available substrate with a photo-polymerizable fluid (comprising suitable monomers) by capillary forces, suction forces, centrifugal forces, doctor blading, spin coating and/or dipping and
b) subsequently photo-polymerizing locally through a mask
c) a washing step to remove the non-cross linked fluid
d) providing capture molecules locally in the first areas e.g. by ink-jet or other printing techniques (this step may optionally comprise a method to cross link the capture probes to the inner surface of the substrate material and additional washing or surface treatment steps).

According to an embodiment of the present invention, the method of making a substrate material according to the present invention comprises the following steps:

a) Locally filling a substrate material with a photo-polymerizable fluid (comprising suitable monomers) by e.g. ink-jet or other printing techniques
b) subsequently photo-polymerizing, preferably using flash exposure
c) providing capture molecules locally in the first areas e.g. by ink-jet or other printing techniques (this step may optionally comprise a method to cross link the capture probes to the inner surface of the substrate material and additional washing or surface treatment steps).

According to an embodiment of the present invention, the method of making a substrate material according to the present invention comprises the following steps:

a) Locally filling substrate material with a temporary material (e.g. such as wax or sugar) by e.g. ink-jet or other print techniques and
b) subsequently filling the substrate material in the areas where the second areas are to be provided completely with a photo-polymerizable fluid (comprising a suitable monomer)
c) photo-polymerizing, preferably using flash exposure,
d) a washing and/or heating step to remove the temporary material
e) providing capture molecules locally in the first areas e.g. by ink-jet or other printing techniques (this step may optionally comprise a method to cross link the capture probes to the inner surface of the substrate material and additional washing or surface treatment steps).

According to an embodiment of the present invention, the method of making a substrate material according to the present invention comprises the following steps:

a) Providing a carrier mesh out of a metal or polymer with holes and
b) filling the holes with a suitable material mix: a polymerization-induced phase separating medium, which consists of a non-solvent (NS) and monomer system, which can be photo-polymerized,
c) photo-polymerization
d) a washing step to remove the NS and possibly remaining monomers.
e) providing capture molecules locally in the first areas e.g. by ink-jet or other printing techniques (this step may optionally comprise a method to cross link the capture probes to the inner surface of the substrate material and additional washing or surface treatment steps).

According to an embodiment of the present invention, the method of making a substrate material according to the present invention comprises the following steps:

a) Providing a carrier mesh out of a metal or polymer with holes and
b) filling the holes e.g. by ink-jet printing with a suitable material mix: a polymerization-induced phase separating medium comprising additionally capture probes,
c) photo-polymerization
d) a washing step to remove the NS and possibly remaining monomers and capture probes that are not linked to the substrate material.

According to an embodiment of the present invention, the method of making a substrate material according to the present invention comprises the step of

a) Depositing (on a temporary carrier substrate) a suitable material mix: a polymerization-induced phase separating medium, which consists of a non-solvent (NS) and monomer system, which can be photo-polymerized.
b) Providing the second areas in a first photo-polymerization step through a mask making the second areas with a low porosity.
c) Providing the first areas with a high porosity in a second exposure step
d) A washing step to remove the NS and possibly remaining monomers.
e) Removing the temporary carrier substrate.
f) Providing capture molecules locally in the first areas e.g. by ink-jet or other printing techniques (this step may optionally comprise a method to cross link the capture probes to the inner surface of the substrate material and additional washing or surface treatment steps).

Steps d) e) and f) can be performed in another order.

According to an embodiment of the present invention, the method of making a substrate material according to the present invention comprises the step of local electrolytical oxidation of a metal template.

According to an embodiment of the present invention, in this method, the metal template is made out of Aluminum, tantalum, or titanium, or metal alloys, or doped metals or alloys.

According to an embodiment of the present invention, in this method, the oxidation is achieved by using small electrodes, according to an embodiment essentially of the size of the first area(s).

A substrate material and/or a material made according to a method according to the present invention may be of use in a broad variety of systems and/or applications, amongst them one or more of the following:

biosensors used for molecular diagnostics

rapid and sensitive detection of proteins and nucleic acids in complex biological mixtures such as e.g. blood or saliva

high throughput screening devices for chemistry, pharmaceuticals or molecular biology

testing devices e.g. for DNA or proteins e.g. in criminology, for on-site testing (in a hospital), for diagnostics in centralized laboratories or in scientific research

tools for DNA or protein diagnostics for cardiology, infectious disease and oncology, food, and environmental diagnostics

tools for combinatorial chemistry

analysis devices

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

### BRIEF DESCRIPTION OF THE DRAWINGS

Additional details, features, characteristics and advantages of the object of the invention are disclosed in the subclaims, the figures and the following description of the respective figures and examples, which—in an exemplary fashion—show several preferred embodiments of a substrate material as well as a device according to the invention.

FIG. 1 shows a very schematic top view of a substrate material according to a first embodiment of the present invention;

FIG. 2 shows a very schematic cross-sectional cut-out view of the substrate material along the line II-II in FIG. 1;

FIG. 3 shows a very schematic cross-sectional cut-out view of a substrate material according to a second embodiment of the present invention in the same perspective as FIG. 2;

FIG. 4 shows a very schematic cross-sectional cut-out view of a substrate material according to a second embodiment of the present invention in the same perspective as FIG. 2;

FIG. 5 shows a cut-out view of a mask pattern that was used for the fabrication of two substrate materials according to a third and fourth embodiment of the present invention;

FIG. 6 shows a cut-out view of a substrate material according to a third embodiment of the present invention; and

FIG. 7 shows a cut-out view of a substrate material according to a fourth embodiment of the present invention.

### DETAILED DESCRIPTION OF THE DRAWINGS

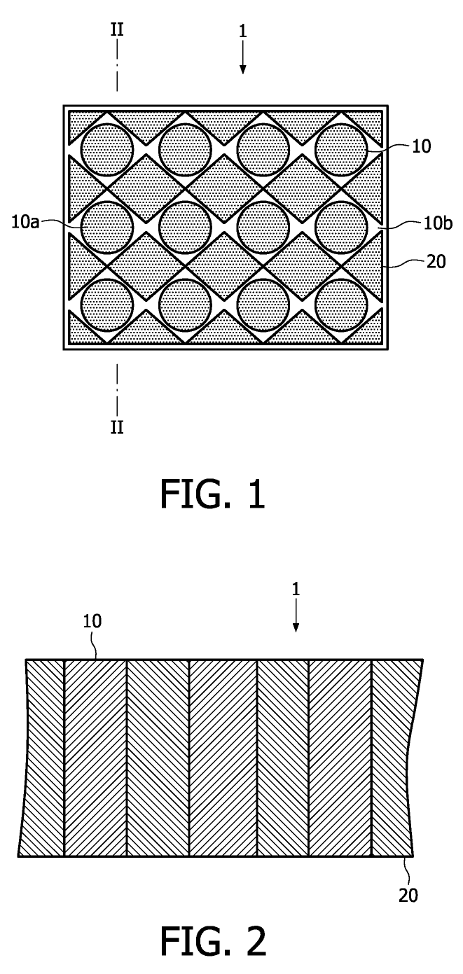

FIG. 1 shows a very schematic top view of a substrate material 1 according to a first embodiment of the present invention, FIG. 2 shows a very schematic cross-sectional cut-out view of the substrate material 1 along the line II-II in FIG. 1. In this embodiment, there are first areas 10 which form a regular pattern and which are surrounded by second areas 20.

In this embodiment, the first areas 10 include areas 10a where binding substances are present (as indicated by grey circles). Each different circle will preferably contain a different binding substance in order to analyse a plurality of analytes in the sample. The first areas 10 also include areas 10b where no binding substances are present and which may be used to measure “background noise”.

As can be seen from FIG. 2, both the first areas 10 and second areas 20 areas are provided somewhat in the form of columns. The substrate material was made by using photo-polymerization induced phase separation as described above.

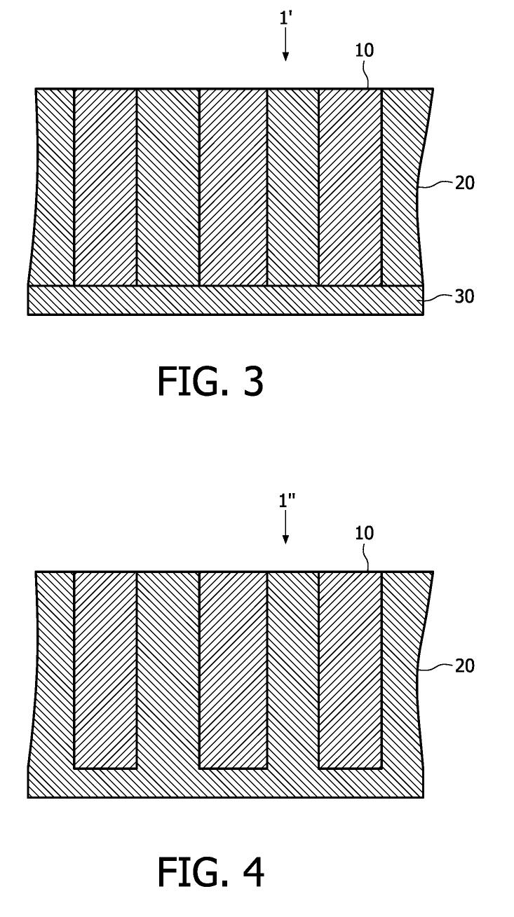

FIG. 3 shows a very schematic cross-sectional cut-out view of a substrate material 1″ according to a second embodiment of the present invention in the same perspective as FIG. 2. The difference in this embodiment is that a further layer 30 was introduced, which allows the transport of analyte from each first area 10 to the next. The layer 30 may be out of the same material as that used for the first areas 10; however any material known in the field which allows a suitable movement of analyte in order to achieve a transport between the first areas 10 may be used.

FIG. 4 shows a very schematic cross-sectional cut-out view of a substrate material 1″ according to a second embodiment of the present invention in the same perspective as FIG. 2. In this embodiment, the second areas 20 were made by photo-polymerization induced phase separation using holographic techniques. The embodiment of FIG. 4 may be considered similar as the embodiment of FIG. 3 only that the layer 30 (of FIG. 3) and the first areas 10 are “fused”.

The invention will further be understood by the following Examples I and II which—in a merely illustrative fashion—show the fabrication of two substrate materials according to a third and fourth embodiment of the present invention.

### EXAMPLE I

In Example I the following mixture was used for a PIPS fabrication of a substrate material according to a third embodiment of the present invention.

Mixture 1: 50% n-pentylcyanobiphenyl (K15, Merck)+49.5% tetraethyleneglycoldimethacrylate (TEGDMA, Fluka)+0.5% Irgacure 651 (photo-initiator, Irgacure 651, Ciba Specialty Chemicals).

On a first 0.7 mm glass plate two pieces of Scotch tape 50 μm were placed with a distance between the tapes of about 0.5 mm. A 100 μm thin glass plate was placed on top and the resulting spacing between the glass plates and the tapes was filled with mixture 1.

Both glass plates were coated (before use) with an adhesion prohibitor such as chlorosilane with a fluorinated alkane endgroup in order to allow release of the membrane from the temporary glass substrates. In this example the compound used was C₁₂H₁₀ClF₁₇Si (ABCR, CAS 74612-30-9).”

The sample was placed in a stainless steel chamber with a UV-transparent lid (B270 glass), which was continuously flushed with nitrogen. Directly on top of the sample a mask was placed. The mask pattern is depicted in FIG. 1. The sample was exposed for 60 s to UV light (14.4 mWcm⁻², exposure unit: Oriel Instruments, model: 92531-1000).

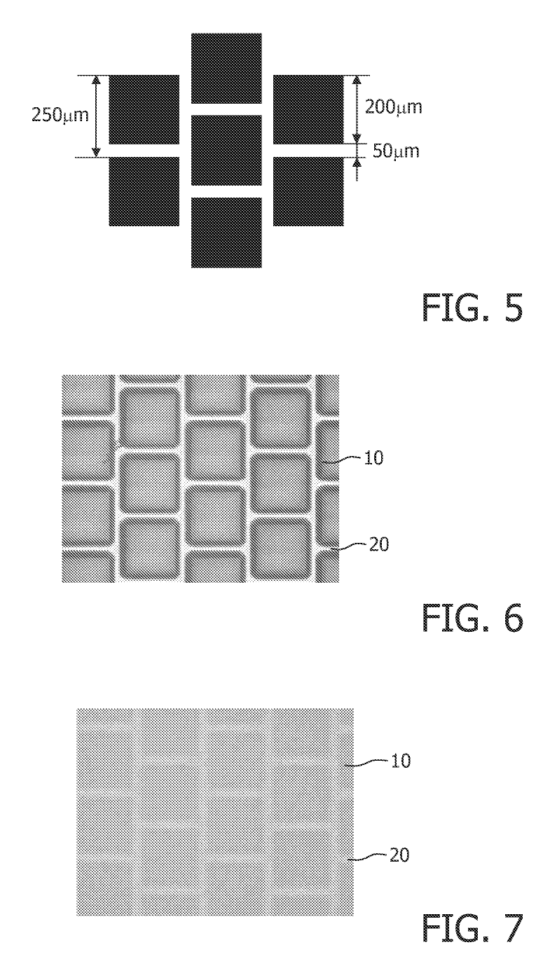

A cut-out view of this mask pattern can be seen in FIG. 5.

The sample was then placed in a second stainless steel chamber with a UV-transparent lid (B270 glass) and exposed to a second UV source (Philips PL10, 1 mWcm⁻²) for 15 minutes. After 8 minutes the sample becomes turbid and starts to scatter white light. This indicates the onset of the phase separation in the first areas.

Then, the two glass plates were separated. The membrane stayed adhered to the thin top glass plate. Subsequently, the sample was rinsed with hexane to remove the n-pentylcyanobiphenyl. After evaporation of the hexane, the resulting morphologies were examined with optical microscopy.

FIG. 6 shows a cut-out view of this substrate material according to a third embodiment of the present invention. The membrane is illuminated from the bottom. The fine structures in the second areas 20 indicate that some phase separation has occurred. The darker appearance of the first areas 10 is the result of more scattering, which indicates that locally much more pores were formed.

It should be noted that in this substrate material no flow occurs between the different first areas 10. Therefore in a device employing the substrate material preferably a further layer (not shown) is introduced which allows such a flow.

### EXAMPLE II

In Example II the following mixture 2 was used for a PIPS fabrication of a substrate material according to a fourth embodiment of the present invention.

Mixture 2: 70% n-pentylcyanobiphenyl (K15, Merck)+29.5% tetraethyleneglycoldimethacrylate (TEGDMA, Fluka)+0.5% Irgacure 651 (photo-initiator, Irgacure 651, Ciba Specialty Chemicals).

Cell making and exposure steps were identical to Example I. After the mask exposure step it was found by optical microscopy that in the second areas 20 already some phase separation had occurred. The onset of the phase separation of the first areas 10 in the flood exposure was earlier than in Example 1: <4 minutes.

FIG. 7 shows the resulting membrane after separation of the glass plates, dissolution of the n-pentylcyanobiphenyl (K15) with hexane and subsequent evaporation of the hexane. Compared to Example I the membrane has a much more white appearance, indicating a higher (overall) porosity (thickness of the samples was equal: 50 μm).

It should be noted that in this substrate material, too, no flow occurs between the different first areas 10. Therefore in a device employing the substrate material preferably a further layer (not shown) is introduced which allows such a flow.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. A substrate material for analyzing one or more fluid samples for the presence, amount or identity of one or more analytes in the samples, whereby
(a) defined first areas on or with the substrate material are provided with at least one binding substance specific for at least one of said analytes, such first area(s) having a porosity of ≧50% and ≦99% and
(b) at least one defined second area on or with the substrate material is provided with a porosity of ≧0% and ≦50%.

2. The substrate material according to claim 1, whereby the mean diameter of the first areas is ≧10 μm and ≦1 mm.

3. The substrate material according to claim 1, whereby the ratio of the total volume of the first areas (in mm³) to the total volume of the at least one second area (in mm³) is ≧0.5:1 and ≦10:1.

4. A substrate material according to claim 1, whereby the first areas are arranged in a regular and/or periodic array pattern.

5. A substrate material according to claim 1, whereby the material of the first areas and/or the second areas and/or the substrate as a whole is chosen from the group comprising
amorphous polymers, preferably from the group comprising PC (polycarbonate), PS (polystyrene), PMMA (polymethylmethacrylate), cellulose ester, cellulose nitrate, cellulose acetate, cellulose or mixtures thereof,
semicrystalline polymers, preferably from the group comprising PA (polyamide=nylon materials), PTFE (polytetrafluoroethylene), polytrifluoroethylene, PE (polyethylene), PP (polypropylene), or mixtures thereof,
rubbers, preferably from the group comprising PU (polyurethane), polyacrylates, silane based polymers such as PDMS (polydimethylsiloxane) or mixtures thereof,
gels (=polymer networks with fluid solvent matrix), preferably from the group comprising agarose gel, polyacrylamide gel or mixtures thereof
metals (such as aluminum, tantalum, titanium), alloys of two or more metals, doped metals or alloys, metal oxides, metal alloy oxides or mixtures thereof or mixtures thereof.

6. A substrate material according to claim 1 whereby the thickness of the substrate material is ≧1 μm and ≦500 μm.

7. A substrate material according to claim 1 whereby the thermal conductivity (in W/m K) in at least a part of said second areas is ≧2 times larger than in said first areas.

8. A method of making a substrate material according to the present invention, comprising a photo polymerization step.

9. A method of making a substrate material according to the present invention, comprising polymerization induced phase separation.

10. A system incorporating a substrate material according to claim 1 and being used in one or more of the following applications:
biosensors used for molecular diagnostics
rapid and sensitive detection of proteins and nucleic acids in complex biological mixtures such as e.g. blood or saliva
high throughput screening devices for chemistry, pharmaceuticals or molecular biology
testing devices e.g. for DNA or proteins e.g. in criminology, for on-site testing (in a hospital), for diagnostics in centralized laboratories or in scientific research
tools for DNA or protein diagnostics for cardiology, infectious disease and oncology, food, and environmental diagnostics
tools for combinatorial chemistry
analysis devices.
